(19) United States
(12) Patent Application Publication
(10) Pub. No.: US 2026/0012661 A1
(43) Pub. Date: Jan. 8, 2026

(54) DLobby

(71) Applicant: David Haskia, Arvada, CO (US)

(72) Inventor: David Haskia, Arvada, CO (US)

(21) Appl. No.: 18/765,293

(22) Filed: Jul. 7, 2024

(51) Int. Cl. H04N 21/23

(52) U.S. Cl. CPC H04N 21/23

(57) ABSTRACT

The invention at hand is a cutting-edge application that leverages real-time, user-generated feedback and visual data which serves as an invaluable tool for individuals seeking to make informed decisions about visiting public spaces, such as bars, restaurants, clubs, banks, post offices, DMVs and more. By utilizing live images and firsthand accounts from nearby users, the application provides an up-to-the-minute assessment of the crowd density at a specific location, enabling users to determine whether a place is excessively crowded or relatively empty. Users can seamlessly request visual updates, including photographs and brief video snippets of up to 10 seconds, allowing for a comprehensive understanding of the current situation.

### BACKGROUND OF THE INVENTION

Traditionally, assessing crowd density and making informed decisions about visiting public spaces relied on limited and indirect methods. Individuals often had to physically visit the location to ascertain the current crowd situation, leading to potential time wastage and inconvenience. Alternatively, some establishments utilized basic manual systems, such as staff estimates or simple headcounts, to gauge crowd density and manage customer flow. However, these methods were prone to inaccuracies and were unable to provide real-time insights into the dynamic nature of crowd fluctuations.

Furthermore, in the absence of technological solutions, individuals had to rely on word-of-mouth information or generalized assumptions about the crowd situation at various public spaces. This approach lacked precision and often resulted in subjective and unreliable assessments, leading to suboptimal decision-making and potential dissatisfaction among customers.

Overall, the traditional methods for assessing crowd density and making informed decisions about visiting public spaces were characterized by inefficiencies, subjectivity, and a lack of real-time insights, highlighting the need for a more sophisticated and technology-driven approach to address these challenges.

One of the key limitations is the reliance on outdated and imprecise methods for gauging crowd density, such as manual headcounts or estimations, which often lead to inaccuracies and unreliable data. This lack of real-time and accurate information poses challenges for individuals seeking to make timely and informed decisions about visiting public spaces.

Additionally, the absence of a streamlined and user-friendly platform for accessing real-time visual updates has created a significant gap in the market. Users have been unable to seamlessly request and receive dynamic visual data, including images and short video snippets, to assess the current crowd situation in specific locations. This limitation has hindered the ability to make informed decisions based on comprehensive and up-to-date information.

Furthermore, the prior art has often been confined to specific sectors or industries, offering limited scope and applicability across diverse public spaces. This lack of inclusivity has resulted in fragmented and siloed approaches to crowd density assessment, failing to provide a holistic and comprehensive solution that caters to a wide range of user needs and preferences.

Overall, the prior art's reliance on outdated methods, the absence of a streamlined visual data access platform, and the limited scope of applicability have collectively contributed to significant complications and shortcomings in effectively addressing the challenges associated with crowd density assessment and informed decision-making in public spaces.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

The invention at hand is a cutting-edge application that leverages real-time, user-generated feedback and visual data to address a persistent concern in everyday life. The application serves as an invaluable tool for individuals seeking to make informed decisions about visiting public spaces, such as bars, restaurants, clubs, banks, post offices, DMVs and more. By utilizing live images and firsthand accounts from nearby users, the application provides an up-to-the-minute assessment of the crowd density at a specific location, enabling users to determine whether a place is excessively crowded or relatively empty. This functionality proves particularly advantageous in scenarios where time efficiency and convenience are paramount, such as assessing the length of queues at banks or service centers before physically arriving at the location. Users can seamlessly request visual updates, including photographs and brief video snippets of up to 10 seconds, allowing for a comprehensive understanding of the current situation. Ultimately, the application aims to empower individuals with the ability to optimize their time management and enhance their decision-making process, fostering a more streamlined and efficient approach to navigating public spaces.

The innovation introduces several new and novel concepts that significantly differentiate it from existing solutions. First and foremost, the application's reliance on live, user-generated feedback and visual data presents a groundbreaking approach to addressing the problem of crowd density assessment in public spaces. By integrating real-time images and firsthand accounts from nearby users, the application ensures an up-to-the-minute evaluation of the current situation, offering a level of immediacy and accuracy that is unparalleled in existing solutions.

Furthermore, the incorporation of a seamless request mechanism for on-demand visual updates, encompassing both photographs and brief video snippets of up to 10 seconds, represents a pioneering feature in the realm of crowd monitoring applications. This allows users to gain a comprehensive and dynamic understanding of a location's crowd density, facilitating informed decision-making with a level of detail and context that was previously unavailable.

Moreover, the application's broad scope, encompassing various public spaces ranging from leisure venues like bars and restaurants to essential service providers like banks, post offices, and DMVs, marks a significant departure from conventional solutions that often cater to specific sectors or industries. This inclusive approach ensures that users can benefit from the application's insights across a diverse array of locations, enhancing its practicality and utility in everyday life.

Overall, the combination of real-time data, dynamic visual updates, and a comprehensive scope across diverse public spaces underscores the invention's unique and pioneering contribution to the field, setting it apart as a truly innovative solution in the realm of crowd density assessment and decision support applications.

### DETAILED DESCRIPTION OF THE INVENTION

We currently have three distinct embodiments (models) of our invention, each tailored to address specific user needs and preferences. These embodiments encompass unique sets of features and functionalities, enhancing the application's versatility and adaptability across various scenarios.

The first embodiment focuses on providing a streamlined and user-friendly interface for accessing real-time crowd density information and visual updates. It emphasizes simplicity and ease of use, catering to users who prioritize quick and convenient access to relevant data.

The second embodiment is designed to offer enhanced customization options, allowing users to personalize their experience by setting specific preferences and parameters for receiving crowd density alerts and notifications. This model caters to individuals who seek a more personalized and tailored approach to managing their interactions with public spaces.

The third embodiment emphasizes comprehensive data analytics and reporting capabilities, enabling users to access detailed insights and trends related to crowd density fluctuations over time. This model is tailored for users who require in-depth analytics and data-driven decision-making support for optimizing their interactions with various public venues.

By offering these three distinct embodiments, we aim to cater to a diverse range of user preferences and requirements, ensuring a comprehensive and adaptable solution that effectively addresses the challenges associated with crowd density assessment and informed decision-making in public spaces.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

I claim:

1. An Application for informing prospective attendees of a public venue, to request photographs or up to 10 second videos or textual accounts of people already at said location, thereby notifying said prospective attendee of the current crowd density at said location, prior to the prospective attendee attending.

2. The Application of claim 1, wherein said public spaces can be bars, restaurants, clubs, banks, post offices, DMVs and more.

3. The Application of claim 1, wherein said Application enables users to determine whether a venue is excessively crowded or relatively empty, prior to said users actually attending said venue.

4. The Application of claim 1, wherein users can seamlessly request visual updates, including photographs and brief video snippets of up to 10 seconds, allowing for a comprehensive understanding of the current situation.

5. The Application of claim 1, wherein a second embodiment of the Application allows users to personalize their experience by setting specific preferences and parameters for receiving crowd density alerts and notifications.

6. The Application of claim, 1 wherein a third embodiment of the Application emphasizes comprehensive data analytics and reporting capabilities, enabling users to access detailed insights and trends related to crowd density fluctuations over time.

7. The Application of claim 1, wherein a first embodiment of the Application focuses on providing a streamlined and user-friendly interface for accessing real-time crowd density information and visual updates.

8. The Application of claim 1, wherein the application incorporates a seamless request mechanism for on-demand visual updates, encompassing both photographs and brief video snippets of up to 10 seconds.
